(19) United States
(12) Patent Application Publication
(10) Pub. No.: US 2009/0103916 A1
(43) Pub. Date: Apr. 23, 2009

(54) OPTICAL CHASSIS MONITORING

(75) Inventor: William E. Dolan, III, Southold, NY (US)

Correspondence Address: GOODWIN PROCTER LLP;PATENT ADMINISTRATOR, 53 STATE STREET, EXCHANGE PLACE, BOSTON, MA, 02109-2881, US

(73) Assignee: CSC Holdings, Inc., Bethpage, NY (US)

(21) Appl. No.: 11/874,367

(22) Filed: Oct. 18, 2007

(51) Int. Cl. H04B 10/08; G06F 17/30

(52) U.S. Cl. 398/9; 707/100; 707/101; 707/103 Y; 707/3

(57) ABSTRACT

Systems and methods for processing event data provided by a managed device which includes a plurality of components. One or more components are identified based on the event data, providing, for example, more accurate information for purposes of network management and equipment maintenance. Applications include the identification of one or more optical modules within an SNMP-managed optical chassis in a hybrid-fiber-coaxial cable-television network.

### FIELD OF THE INVENTION

This invention relates to network management, and more particularly to a system and method for managing hybrid-fiber-coaxial networks for cable television applications.

### BACKGROUND

Modern cable television systems employ hybrid-fiber-coaxial (HFC) architectures, which combine a core fiber-optic network with cable-based peripheral branches carrying the television signal to individual customers. Cable TV content is generally provided by a cable operator's central office or by a “headend,” which is a facility that receives content from a plurality of media (satellite, broadcast TV, wired and optical networks, etc). The fiber-optic network connects the central office or headend to a number of “hubs” that serve entire neighborhoods. Each hub is connected to one or more “optical nodes” that interface the optical network to a conventional radio-frequency (RF) cable network by converting optical signals to electrical signals and vice versa. A hub includes a certain number of optical receivers/transmitters that send and receive data from/to the optical nodes. In order to conserve space and reduce installation and management costs, optical receivers/transmitters are manufactured as circuit-board modules, and several modules are mounted within a single chassis.

Managing a large number of network devices spread over a wide geographical area creates substantial costs. The Society of Cable Telecommunications Engineers (SCTE) has developed a specification for monitoring HFC networks called the Hybrid Management System (HMS). The HMS standard is based on the Simple Network Management Protocol (SNMP), which allows the remote management of networked devices. The data structures supported by the HMS specification provide status and performance data about an optical chassis and its modules. For example, specific data structures relate to whether a module's performance parameters are within a predetermined acceptable range. Out-of-range performance parameters typically correlate to outages and poor customer experience. When this happens, alarms from the devices are processed by network operators and physically investigated by technicians. The use of this technology reduces mean time to repair (MTTR) by eliminating the need to physically inspect the hub to determine equipment status.

One problem with prior-art monitoring systems based on HMS is that each chassis is typically modeled as a single SNMP-managed device. Therefore, the system can only recognize the existence of a problem associated with an entire optical chassis, and cannot diagnose the nature of the problem itself or identify the chassis component involved. This prevents correlating, for example, an equipment failure alarm to the specific optical transmitters/receivers that caused the failure, and therefore identifying the customers affected by the failure.

### SUMMARY OF THE INVENTION

The present invention solves the aforementioned problems of the prior art by facilitating identification of one or more specific components associated with an event. Embodiments of the invention are directed toward systems and methods for managing network devices, where each device may include a plurality of components. In one embodiment, a method in accordance with the invention includes two phases, a discovery phase and an event-handling phase. During the discovery phase, appropriate databases are built corresponding to the managed device and its components. During the event-handling phase, these databases are used to identify the component(s) associated with a specific event. For example, at discovery time the managed device and its components may be represented by “objects,” each described by a “model.” Also, “relationships” may be stored linking each component to the managed device. When event data are received from the managed device, the object database may be queried to obtain a managed-device model, which may be used to identify the component(s) associated with the event by querying the object database and the relationship database. The event may then be handled in relation to one of the components rather than the entire managed device.

In a first aspect, therefore, the invention comprises a method for processing event data provided by a managed device, which itself comprises a plurality of components. The method may include the steps of receiving the event data from the managed device; obtaining a managed device identifier based on the event data; obtaining a managed device model corresponding to the managed device identifier; and identifying at least one component based on the event data and the managed device model, where the component is associated with the event. The managed device identifier may be obtained by parsing the event data, and the component(s) may be identified by parsing the event data according to the managed device model. Also, the managed device model may be obtained by querying a first database, and the component(s) may be identified by querying a second database. In some embodiments of the invention, the first database includes an object database, and the second database includes a relationship database. The method may further include the steps of obtaining a managed device identifier; obtaining a managed device model from the managed device identifier; storing an entry in the first database associating the managed device identifier with a managed device model; obtaining component identifiers for each of the components; and for each of the component identifiers, storing an entry in the second database associating the managed device identifier and at least one component identifier with at least one component. The step of obtaining the managed device model from the managed device identifier may include requesting information from the managed device identifying the managed device type, and/or querying a third database based on the managed device identifier. The step of obtaining component identifiers may include requesting component identifiers from the managed device, and/or querying a fourth database based on the managed device model. The managed device may be an SNMP-managed device, and the event data may include an object identifier. The step of obtaining a managed device identifier may include extracting the network address of the managed device from the event data, and identifying at least one component may include extracting a component object identifier from the object identifier. In particular embodiments, the event data may be received in response to a polling message sent from a network management station to the managed device, and/or as part of a trap message sent by the managed device to a network management station. In some embodiments of the invention, the managed device includes an optical chassis; the components include optical transmitter/receiver modules; identifying the at least one component includes identifying a component that generated an alarm; and event data include alarm data.

In another aspect, the invention comprises a method for handling event data in a network that includes a managed device that comprises a plurality of components. The method may include the steps of storing, in an object database, a managed device object; storing, in the object database, one component object for each of the components; storing, in a relationship database, one relationship for each of the component objects, where each relationship associates a component object with the managed device object; receiving event data from the managed device; obtaining the managed device object from the event data and the object database; and identifying one or more component objects from the event data, the managed device object, and the relationship database, where the component object(s) correspond to one or more components associated with the event. The step of obtaining the managed device object may include: parsing the event data to obtain a managed device identifier; and querying the object database based on the managed object identifier. The step of identifying component object(s) may further include: parsing the event data according to the managed device object to obtain a component identifier; and querying the relationship database and the object database based on the component identifier. The step of querying the relationship database and the object database may include: querying the relationship database to obtain a set of component objects; and querying the object database to obtain the at least one component object from the set of component objects and the at least one component identifier.

In another aspect, the invention provides a system for processing event data provided by a managed device that includes a plurality of components. The managed device is associated with a managed device identifier, and each component is associated with a component identifier. The system may comprise: a first database associating the managed device identifier with a managed device model; a second database associating the managed device identifier and at least one component identifier with at least one component; and a computer system, responsive to the event data, programmed for identifying at least one component from the first database, the second database, and the event data. In particular embodiments, the computer system may comprise: a first running process for parsing the event data to obtain the managed device identifier; and a second running process for parsing the event data according to the managed device model to obtain at least one component identifier. The computer system may also comprise: a third running process for querying the first database to obtain the managed device model from the managed device identifier; and a fourth running process for querying the second database to identify the at least one component from the managed device identifier and the at least one component identifier.

In yet another aspect, the invention comprises a computer-readable medium storing a program for processing event data provided by a managed device that comprises a plurality of components. The program may comprise instructions for: receiving the event data from the managed device; obtaining a managed device identifier based on the event data; obtaining a managed device model corresponding to the managed device identifier; and identifying at least one component based on the event data and the managed device model.

### BRIEF DESCRIPTION OF THE DRAWINGS

In the drawings, like reference characters generally refer to the same features or steps throughout the different views. The drawings are not necessarily to scale, emphasis instead generally being placed upon illustrating the principles of the invention. In the following description, various embodiments of the invention are described with reference to the following drawings, in which:

FIG. 1 shows the general structure of an HFC network to which the present invention may be applied.

FIG. 2 schematically illustrates the organization of a hub.

FIG. 3 illustrates some of the data structures employed by the SNMP standard.

FIG. 4 shows a schematic representation of an HFC optical chassis.

FIG. 5 illustrates an exemplary implementation of a system in accordance with the present invention.

FIG. 6 illustrates possible data structures stored in the object, model and relationship databases.

FIG. 7 illustrates the flow chart of a method in an embodiment of the invention.

### DETAILED DESCRIPTION

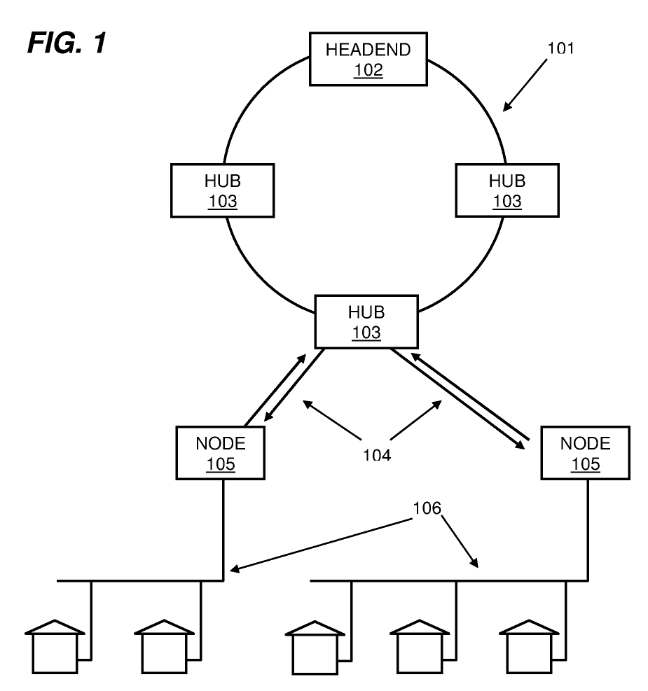

FIG. 1 shows the general structure of an HFC network to which the present invention may be applied. While an HFC network is used as an illustration, it is understood that the invention can be applied to other network structures, such as optical networks, wireless networks, wired networks, and other types of hybrid networks. In the HFC network of FIG. 1, a core optical network 101 may include a headend 102 and a plurality of hubs 103. Both the headend 102 and the hubs 103 usually include numerous pieces of networking equipment and are housed in network utility rooms. The headend typically provides the majority of the content delivered to customers; the remainder (e.g., voice calls, local public access programming) is provided directly at a hub 103. A pair of optical fibers 104 (one for each signal direction) may connect each hub to one or more optical nodes 105. An optical node 105 is a small, relatively simple piece of equipment, typically attached to a utility pole, which converts optical into electrical signals and vice versa. From each node, a branching network 106 of short-haul RF cables reaches individual homes (typically of the order of 1,000 homes for each optical node).

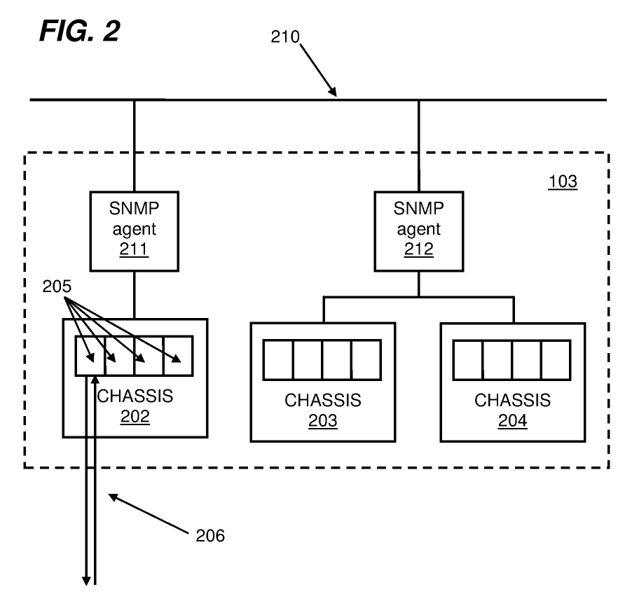

FIG. 2 illustrates the organization of a hub. Each hub 103 typically includes multiple chassis 202-204, each of which may contain several optical modules 205. A pair of optical fibers 206 may connect each optical module to a remote optical node (not shown). It is apparent from this description that each optical module 205 within a chassis typically serves a single node, whereas a chassis serves several nodes and therefore a much larger number of customers.

As FIG. 2 shows, each chassis may be connected to HMS network 210 and communicate with a network management system via SNMP. Although for clarity the HMS network 210 is graphically represented as distinct from the HFC network illustrated in FIG. 1, it is usually implemented by the same physical infrastructure. In general, most SNMP-compliant network appliances operate as stand-alone SNMP-managed devices. A chassis, however, contains a multiplicity of optical modules; that is, a single SNMP-managed device typically corresponds to several components. A single SNMP agent may even serve more than one chassis. In FIG. 2, SNMP agent 211 serves a single chassis 202, whereas SNMP agent 212 serves two chassis 203 and 204.

The exact way in which a chassis communicates with an SNMP managing station depends on the vintage of the equipment. Chassis of recent design include a built-in SNMP agent. Examples of such equipment include the CHP Max5000 Converged Headend Platform, sold by C-COR, State College, PA. Legacy models of pre-HMS design are typically not SNMP-compliant, and instead use proprietary languages such as the “Craft” text-based interface. In this case a separate device, called an “SNMP proxy agent,” may be used to connect those chassis to an HMS-compliant management system. An SNMP proxy agent translates SNMP transactions into the equipment's proprietary language and vice versa. Each SNMP proxy agent can manage one or more chassis. An example of an SNMP proxy agent is Model PBT-SA-1 “SpecialAgent” sold by Phoenix Broadband Technologies, LLC, Montgomeryville, Pa.

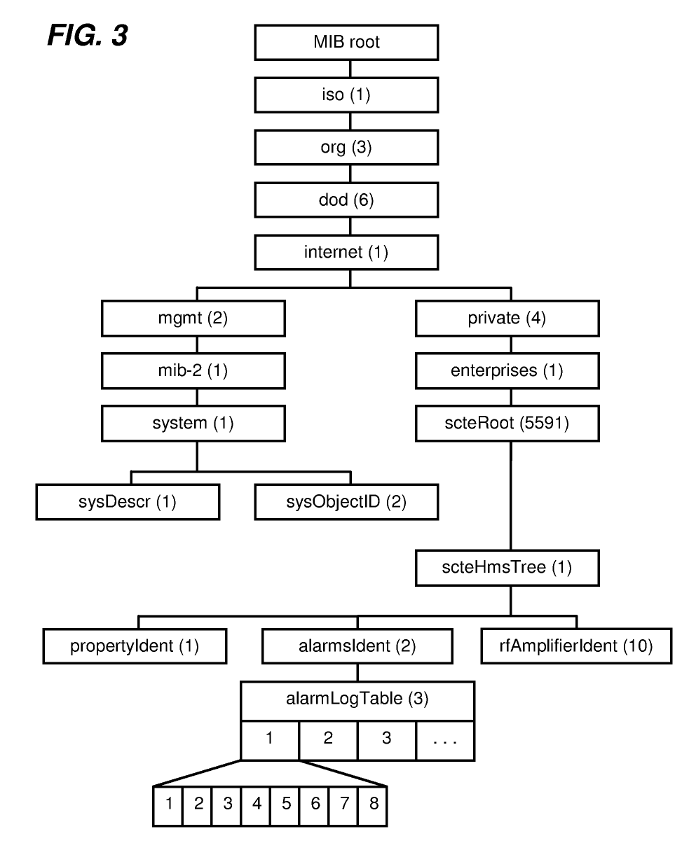

FIG. 3 illustrates some of the data structures employed by the SNMP standard. SNMP version 3 is defined by IETF documents RFC-3411 through RFC-3418, incorporated herein by reference. While SNMP is used as an illustration due to its popularity in network management applications, it is understood that the invention is not limited in any way to the specific features of SNMP, and may be employed in connection with other network management protocols, such as the Common Management Information Protocol (CMIP) defined by the ITU-T X.700 series of recommendations.

SNMP organizes information in a Management Information Base (MIB), a standardized tree structure whose branches can be customized to include information relating to specific network equipment. A complete MIB includes hundreds of variables, and FIG. 3 only shows those few that are relevant to the discussion of this embodiment of the invention. Each SNMP-managed device maintains a MIB corresponding to its internal variables. Each node in the MIB tree is uniquely identified by an Object Identifier (OID). The OID is just a string of numbers corresponding to the path taken at every branch of the MIB tree, starting from the root and ending at the leaves. For example, the OID of the “sysObjectID” variable in FIG. 3 is 1.3.6.1.2.1.1.2.

The HMS specification defines a dedicated root for the HMS MIB tree (“scteHmsTree”), branching off the standard MIB tree. The specification also defines sub-trees, branching off the HMS tree, for the various kinds of data associated with HFC equipment. For example, the “propertyIdent” sub-tree includes basic properties that must be supported by all HMS network elements, whereas the “rfAmplifierIdent” sub-tree relates to RF amplifiers only.

As discussed above, one or more chassis may be connected to an SNMP network-management station through a single SNMP agent, and therefore even multiple chassis, so connected, appear to be a single SNMP-managed device. However, each chassis may actually include several distinct hardware devices, each of which has its own state, failure modes, etc. Each such component of the chassis is represented in the MIB as a “child” module of the chassis “parent.” For a chassis including multiple child modules, each MIB variable is in reality a “table” with a different value for each child module. In the example shown in FIG. 3, the chassis includes eight separate components, each represented as a child module; accordingly, the first element in the “alarmLogTable” variable includes eight separate entries, one for each child module. At boot time, each managed device typically inspects itself and populates appropriate MIB tables for its components.

An embodiment of the invention will now be described based on a network-management system. A network-management system is generally composed of one or more software programs running on a computer system, for managing a network comprising one or more managed devices. The computer system may be for example a server, a workstation or a desktop computer. It is also conceivable that the computer system be a laptop computer or even a handheld device, depending on the size of the network and the number and complexity of the managed devices. For clarity of presentation, this embodiment of the invention will be described with reference to a specific network-management system, the SPECTRUM system sold by Computer Associates, Inc., Islandia, N.Y. Once again, it should be understood that the invention is not limited to the SPECTRUM system, and that it is capable of working with other network-management systems (e.g., Cisco Info Center, sold by Cisco Systems, Inc., San Jose, Calif.; HP OpenView, sold by Hewlett-Packard Co., Palo Alto, Calif.; IBM Tivoli, sold by International Business Machines Corp., Armonk, N.Y.). It is clear that the details of the implementation will be slightly different for each of these systems.

A network-management system such as SPECTRUM maintains a model of the entire managed network, in which each physical managed device is represented by an “object” having properties described by a “model.” Each object may be associated with a model, which includes data structures and procedures to be executed in certain events. The system also maintains a set of “relationships” between objects, e.g., whether an object is contained within another object, or whether two objects are connected to each other.

The SPECTRUM system includes predefined models for standard network equipment such as routers, switches, servers, etc. If a certain device is not in the library, the system may select a “generic SNMP device” model and try to identify which features the unrecognized device supports. As an alternative to the generic model, SPECTRUM allows a user to define custom models for new types of equipment. This embodiment of the invention exploits the model-building capabilities of the system to define a plurality of custom models, one for the chassis and one for each of the child modules. If, for example, all child modules are of the same type, only two models are needed, one for the chassis and one shared by all child modules. It should be understood, however, that the invention applies equally to the case of a heterogeneous chassis including child modules of different types. It should also be understood that a unified child module model can be used for child modules of different types, as long as the differences between the types of child modules are relatively minor. By the same token, different child module models may be used for identical child models, if a different behavior is desired for each child module. As discussed below, the model for the chassis may include two custom procedures, one to be called at discovery time, and another when a specific event occurs, e.g., an alarm is received from a chassis. Each of the models for the child modules may only include procedures to be called when an alarm is received for the particular component that the child module represents.

A network-management system typically discovers new devices on the network automatically, and executes appropriate procedures depending on the type of device discovered. The discovery process may, for example, take the IP address of a new managed device as its initial input. The system may then poll the SNMP device associated with the IP address and identify the managed-device model based on the device's “sysObjectID” variable, located in the “system” sub-tree of the “mib-2” tree (see FIG. 3). As defined by RFC-3418, the “sysObjectID” variable is the OID of the sub-tree assigned to contain custom information for that specific product. Since each device's sub-tree has a unique OID, reading the “sysObjectID” variable is an unambiguous way to determine a managed device's type. Alternatively, the managed device type may be determined based on the IP address alone, for example by associating specific IP ranges with certain device types and storing the association in a database. Once the device type is known, the system may locate a model for it. When the discovered device is identified as a chassis for which a custom model has been defined, a discovery procedure associated with the device may be executed. The discovery procedure may now obtain the child module MIB tables from the device and extract the number and type of child modules. Alternatively, where for example a certain chassis type can only house a certain number and type of child modules, the information may be retrieved from a database without requesting information from the managed device. Once the number and type of the child modules are known, the discovery procedure may create objects for the chassis and for each of the child modules. Also, “contained within” relationships may be defined between the newly created chassis and child module objects. The discovery procedure generally needs to be executed only once, for example, when a new piece of equipment is added to the network. The objects created at discovery time are typically retained within the object database in the network management system and used in subsequent processing of alarms from the chassis.

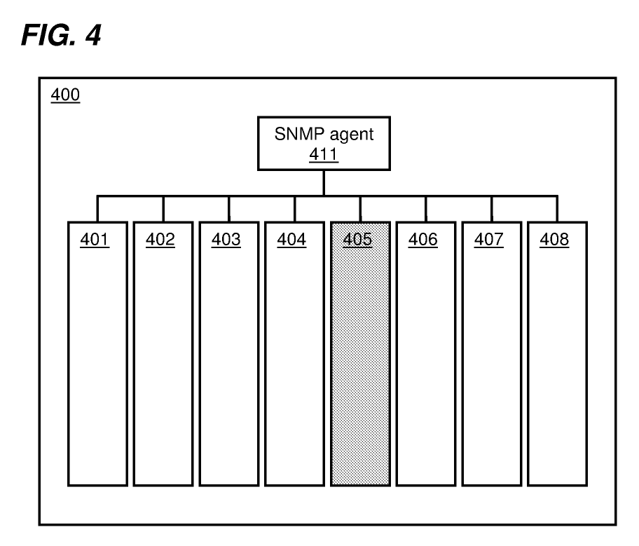

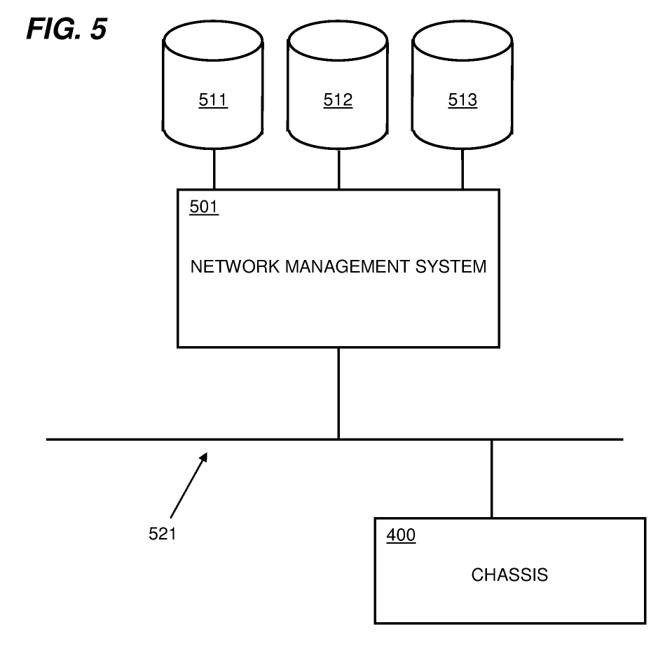

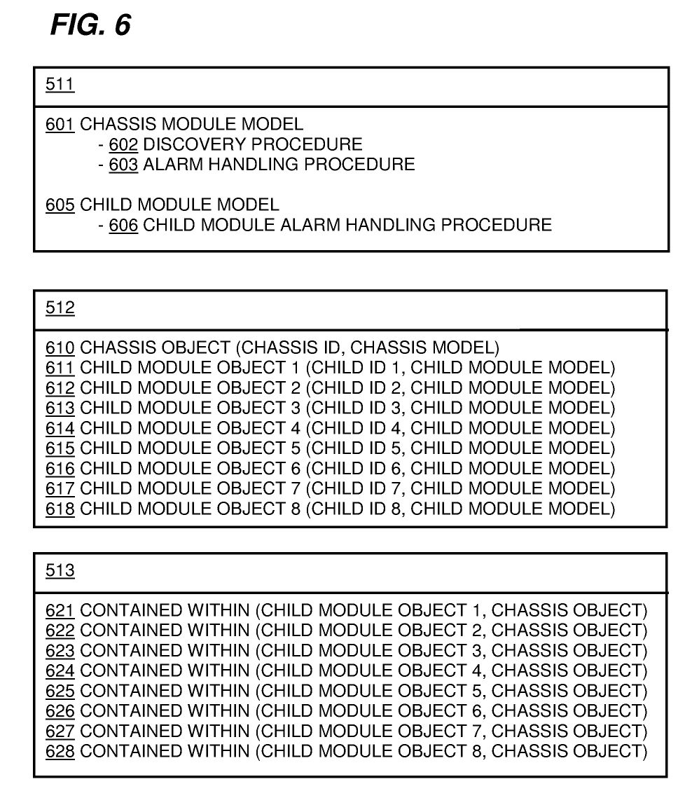

FIGS. 4 through 6 illustrate the operation of an embodiment of the invention. FIG. 4 shows a schematic representation of an HFC optical chassis. Chassis 400 contains eight child modules, indicated by numerals 401 through 408. In this example, chassis 400 also includes a built-in SNMP agent 411. As discussed above, in other embodiments of the invention an SNMP agent may be external to the chassis, and a single SNMP agent may serve more than one chassis. FIG. 5 illustrates an exemplary implementation of a system in accordance with the present invention. The exemplary system 500 shown in FIG. 5 includes a network-management system 501, a model database 511, an object database 512, a relationship database 513, and the chassis 400 which is connected to network-management system 501 via a network 521. FIG. 6 illustrates possible data structures stored in the object, model and relationship databases 511-513 as discussed below.

A representative discovery process is now illustrated with continued reference to FIGS. 4-6. Initially, the network-management system receives, for example, the IP address of the chassis 400, which is being added to the system 500. In response to the IP address, the network-management system 501 requests the “sysObjectID” of the chassis 400. From this, the network-management system 501 can query model database 511 to locate the appropriate chassis model 601. The discovery procedure 602 associated with the chassis model 601 creates nine objects, a chassis object 610 associated with the chassis module 601 and child module objects 611-618. In this example, since all child modules 401-408 are identical, they are all associated with child module model 605. The discovery procedure 602 also creates eight “contained within” relationships 621-628 between each of the child modules and the chassis. In this way the system will later be able to identify the objects corresponding to the particular child modules contained within each modeled chassis.

The objects and relationships created at discovery time may be used, for example, when an alarm is received from the chassis 400. As discussed above, an alarm may correspond to an event requiring intervention, for example, a hardware failure. In the HMS framework an alarm may be generated in one of two ways. In a synchronous polling approach, the network management system may periodically ask each managed device whether it has any alarms pending. In an asynchronous trapping approach, the managed device itself will generate a “trap” to notify the network management system of the alarm. Although the following discussion describes a trapping process, the sequence of events in case of a polling approach is entirely analogous. The difference between trapping and polling lies mainly in the way the network management system 501 obtains event data from the managed device, and does not affect the sequence of events described below.

When the chassis 400 generates a trap to notify the network management system 501 of an alarm, the system may execute the alarm handling procedure 603 associated with the chassis model 601. The HMS alarm data structure is defined in the ANSI/SCTE 38-2 2005 standard (SCTE-HMS-ALARMS-MIB), incorporated herein by reference. The alarm data include, among other things, two key pieces of information:

1. The IP address of the chassis; and

2. The OID of the variable that caused the alarm.

In this embodiment of the invention, the network management system 501 parses the alarm data structure to extract the IP address of the chassis 400. The term “parsing” as used herein denotes the generic step of extracting specific information from a given data structure, and is not limited to specific forms of parsing (e.g., text processing). From the IP address, the network management system may query the object database 512 to determine the chassis object 610 and the chassis model 601 to be used, and execute the associated alarm handling procedure 603. The alarm handling procedure 603 may parse the alarm data structure a second time, this time extracting the OID. As discussed above, an OID is a string of numbers that identify a data item with increasing levels of accuracy. In the case of a chassis, the last element of the OID, or “component OID,” corresponds to the particular child module that generated the alarm.

Taking as an example the MIB shown in FIG. 3 and the chassis 400 shown in FIG. 4, if module 405 (shown in darker shading in FIG. 4) has originated an alarm, the full OID corresponding to the alarm is 1.3.6.1.4.1.5591.1.2.3.1.5. The OID can be broken into three parts. The first part (1.3.6.1.4.1.5591.1) is simply the root of the HMS tree. The second part (2.3.1) identifies the “alarmsIdent” subtree and more specifically the first element in the “alarmLogTable” object which contains a table of all alarms logged. Finally, the numerical value of 5 represents module 405 which generated the alarm.

From the component OID and the chassis object 610, the alarm handling procedure 603 may now identify the particular child module 405 that generated the alarm. In particular, the alarm handling procedure 603 called upon reception of the alarm may now perform a double search:
1. The relationship database 513 is queried to identify all objects related to the chassis object 610 by a “contained within” relationship. All the objects found (i.e., the child module objects 611-618) are stored in an array.
2. The array is searched for all objects that have a component OID that matches the component OID of the alarm (i.e., 5).
   At the end of the search process, the alarm handling procedure 603 returns a “handle” that uniquely identifies the child module object 615 (and the associated child module model 605) corresponding to the particular child module 405 that generated the alarm, as opposed to the chassis 400 that contains the child module 405. It is understood that algorithms other than the double search described above could be used to identify a particular child module object. For example, an array could be maintained for each chassis object to store pointers to each of its child module objects, and the array could be directly indexed by a component OID. This would obviate the double search at the expense of increased storage requirements.

While an embodiment of the invention has been described in which a single component is identified, it is possible to extend the concept to multiple components being identified in correspondence to a single alarm. For example, the alarm data could include multiple component OIDs. In this case the double search could be repeated for each component.

In the last part of the alarm-handling sequence, the network management system 501 may now refer to the object 615 corresponding to child module 405, and not only to the chassis 400 as a whole, to take a variety of responsive actions known in the art, including automated failure analysis, human operator notification, etc. For example, once the child module object is known, the system may query the object database 512 to locate a child module model 605. Next the model database 511 is queried to execute a child module alarm handling procedure 606 that is specific to a single child module rather than generic for the chassis.

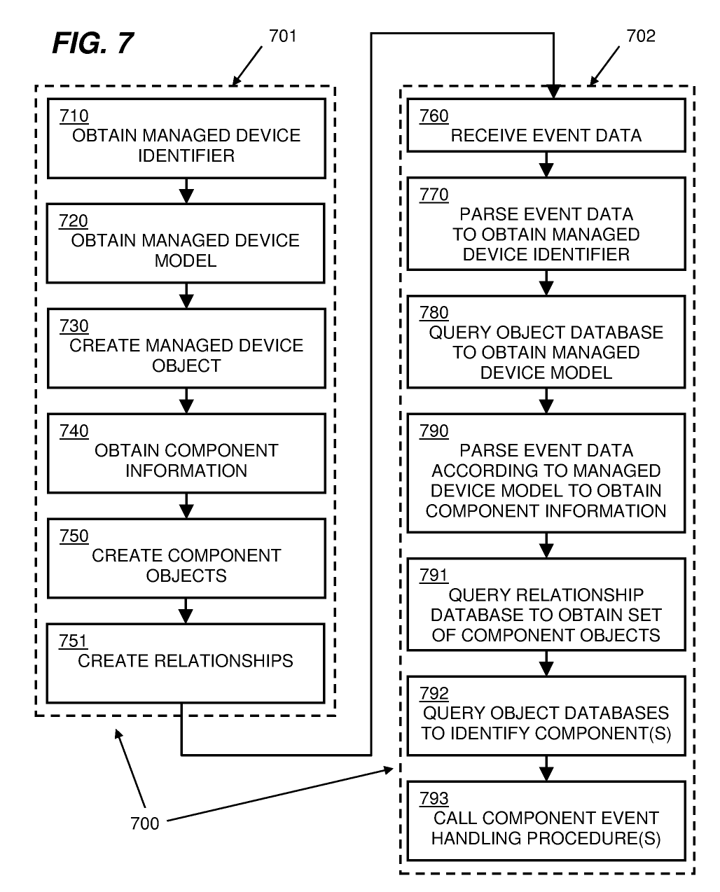

FIG. 7 illustrates the flow chart of a method 700 in an embodiment of the invention. Method 700 includes a discovery phase 701 (steps 710-751) and an alarm handling phase 702 (steps 760-793). In the discovery phase 701, data structures are created in the object and relationship databases, whereas the alarm handling phase 702 is carried out when alarm data is received from the managed device. It should be understood that the flow chart in FIG. 7 is only exemplary, and that the practice of the invention does not require carrying out all the steps as illustrated. For example, the discovery phase 701 may be omitted if appropriate databases are already available.

The discovery phase 701 begins, for example, at step 710, where a managed device identifier is obtained. As discussed above, the managed device identifier may be, for example, the IP address of a device being added to an HMS network. At step 720 a managed device model is obtained from the managed device identifier. This can be achieved, for example, by requesting the managed device's “sysObjectID” data structure and querying the model database accordingly, or by associating the IP address to a managed device model by querying a separate database. At step 730 a managed device object is created, which among other things may associate the managed device identifier with the managed device model. At step 740 component information is obtained for each of the components. For example, the managed device may be polled and information about the number and type of the components, and their component identifiers, may be transmitted from the managed device. Alternatively, the number and type of the components may be inferred from the managed device model. At steps 750-751 data structures representing the components and their relationship to the managed device are created. In particular, at step 750, for each of the components, an object is created which, among other things, may associate each component with component information and a component model. At step 751, a relationship is created between the managed device identifier and each of the components.

After the completion of the discovery phase 701, the alarm handling phase 702 may be carried out. At step 760 event data is received from the managed device, for example in the form of alarm data. The event data may, for example, be received as part of a trap message sent by the managed device. Alternatively, the event data may be sent by the managed device in response to polling by the network management system. At step 770 a managed device identifier is obtained based on the event data, for example by parsing the event data. At step 780 a managed device model corresponding to the managed device identifier is obtained, for example by querying the object database. At steps 790-793 one or more components are identified based on the event data and the managed device model. In particular, at step 790 the event data may be parsed according to the managed device model to obtain one or more component identifiers. At step 791 the relationship database is queried to obtain a set of component objects, for example component objects in a particular relationship to the chassis object. At step 792 the object database is queried to identify one or more components, for example based on the one or more component identifiers and the set of component objects that were previous obtained. At step 793 one or more component event handling procedures are called, for example by querying the object database to locate a component model and its associated procedures.

The availability of specific information about the child module that generated the alarm allows three distinct advantages over the prior art:
1. The network management system is provided with more accurate information for purposes of event correlation and root cause analysis. Since the accuracy of root cause analysis is directly dependent on the quality of the data provided to the system, pinpointing a specific child module as opposed to an entire chassis greatly benefits the analysis.
2. The network manager can correlate the failure of a single optical module with the specific customer base served by that module, rather than with all the customers served by a chassis. The system correctly excludes customers who are served by correctly functioning optical modules and therefore experience no loss of service.
3. The technicians who will physically inspect the hub site and possibly perform maintenance of the chassis are provided with specific information about the specific issue to be resolved, shortening the time needed for investigation and repair.

Although the invention has been described in detail including the preferred embodiments thereof, such description is for illustrative purposes only, and it is to be understood that changes, variations and improvements may be made by those skilled in the art. In particular, while the embodiments of the invention described herein use the management of chassis and optical modules as an example, it is clear that the invention applies to all sorts of network management systems where a managed device includes multiple components. Also, while alarm management has been used as an example, the invention applies to other events, such as incoming data transmissions, manual inputs from a user, detection of physical events by a sensor, software-generated events, etc., or even events generated by the network management system itself for testing or monitoring purposes.

I claim:

1. A method for processing event data provided by a managed device, the managed device comprising a plurality of components, the method comprising:
receiving the event data from the managed device;
obtaining a managed device identifier based on the event data;
obtaining a managed device model corresponding to the managed device identifier; and
identifying at least one component based on the event data and the managed device model, the at least one component being associated with the event.

2. The method of claim 1, wherein the managed device identifier is obtained by parsing the event data, and the at least one component is identified by parsing the event data according to the managed device model.

3. The method of claim 1, wherein the managed device model is obtained by querying a first database, and the at least one component is identified by querying a second database.

4. The method of claim 3, wherein the first database includes an object database, and the second database includes a relationship database.

5. The method of claim 3, further comprising:
obtaining a managed device identifier;
obtaining a managed device model from the managed device identifier;
storing an entry in the first database associating the managed device identifier with a managed device model;
obtaining component identifiers for each of the components; and
for each of the component identifiers, storing an entry in the second database associating the managed device identifier and at least one component identifier with at least one component.

6. The method of claim 5, wherein obtaining the managed device model from the managed device identifier includes requesting information from the managed device identifying the managed device type.

7. The method of claim 5, wherein obtaining the managed device model from the managed device identifier includes querying a third database based on the managed device identifier.

8. The method of claim 5, wherein obtaining component identifiers includes requesting component identifiers from the managed device.

9. The method of claim 5, wherein obtaining component identifiers includes querying a fourth database based on the managed device model.

10. The method of claim 1, wherein the managed device is an SNMP-managed device, and the event data includes an object identifier.

11. The method of claim 10, wherein
obtaining a managed device identifier includes extracting the network address of the managed device from the event data; and
identifying at least one component includes extracting a component object identifier from the object identifier.

12. The method of claim 1, wherein the event data is received in response to a polling message sent from a network management station to the managed device.

13. The method of claim 1, wherein the event data is received as part of a trap message sent by the managed device to a network management station.

14. The method of claim 1, wherein:
the managed device includes an optical chassis;
the components include optical transmitter/receiver modules;
identifying the at least one component includes identifying a component that generated an alarm; and
event data include alarm data.

15. A method for handling event data in a network, the network including a managed device that comprises a plurality of components, the method comprising:
storing, in an object database, a managed device object;
storing, in the object database, one component object for each of the components;
storing, in a relationship database, one relationship for each of the component objects, each relationship associating a component object with the managed device object;
receiving event data from the managed device;
obtaining the managed device object from the event data and the object database;
identifying at least one component object from the event data, the managed device object, and the relationship database, the at least one component object corresponding to at least one component associated with the event.

16. The method of claim 15, wherein obtaining the managed device object includes:
parsing the event data to obtain a managed device identifier; and
querying the object database based on the managed object identifier.

17. The method of claim 15, wherein identifying at least one component object includes:
parsing the event data according to the managed device object to obtain a component identifier; and
querying the relationship database and the object database based on the component identifier.

18. The method of claim 17, wherein querying the relationship database and the object database includes:
querying the relationship database to obtain a set of component objects; and
querying the object database to obtain the at least one component object from the set of component objects and the at least one component identifier.

19. The method of claim 15, wherein:
the managed device includes an optical chassis;
the components include optical transmitter/receiver modules;
identifying the at least one component includes identifying a component that generated an alarm; and
event data include alarm data.

20. A system for processing event data provided by a managed device, the managed device including a plurality of components, the managed device being associated with a managed device identifier, each component being associated with a component identifier, the system comprising:
a first database associating the managed device identifier with a managed device model;
a second database associating the managed device identifier and at least one component identifier with at least one component; and
a computer system, responsive to the event data, programmed for identifying at least one component from the first database, the second database, and the event data.

21. The system of claim 20, wherein the computer system comprises:
a first running process for parsing the event data to obtain the managed device identifier; and
a second running process for parsing the event data according to the managed device model to obtain at least one component identifier.

22. The system of claim 20, wherein the computer system comprises:
a third running process for querying the first database to obtain the managed device model from the managed device identifier; and
a fourth running process for querying the second database to identify the at least one component from the managed device identifier and the at least one component identifier.

23. The system of claim 20, wherein:
the managed device includes an optical chassis;
the components include optical transmitter/receiver modules;
identifying the at least one component includes identifying a component that generated an alarm; and
event data include alarm data.

24. A computer-readable medium storing a program for processing event data provided by a managed device, the managed device comprising a plurality of components, the program comprising instructions for:
receiving the event data from the managed device;
obtaining a managed device identifier based on the event data;
obtaining a managed device model corresponding to the managed device identifier; and
identifying at least one component based on the event data and the managed device model, the at least one component being associated with the event.
